(19) United States
(12) Patent Application Publication
(10) Pub. No.: US 2007/0245382 A1
(43) Pub. Date: Oct. 18, 2007

(54) Digital Broadcast Receiving Apparatus and Method and Program Therefor

(76) Inventors: Shigenori Doi, Hiroshima (JP); Hiroshi Aoki, Hiroshima (JP); Shinji Takeyama, Hiroshima (JP)

Correspondence Address: WENDEROTH, LIND & PONACK L.L.P., 2033 K. STREET, NW, SUITE 800, WASHINGTON, DC, 20006, US

(21) Appl. No.: 11/578,249

(22) PCT Filed: Apr. 21, 2005
(86) PCT No.: PCT/JP05/08090

§ 371 Date: Oct. 12, 2006

(30) Foreign Application Priority Data
Apr. 21, 2004 (JP) 2004-125810

(51) Int. Cl. H04N 5/445

(52) U.S. Cl. 725/55; 725/38; 725/58

(57) ABSTRACT

Disclosed is a digital broadcast receiving apparatus for informing a user that multi-channel broadcasting of a plurality of programs is scheduled to start, prior to the start of the multi-channel broadcasting. The digital broadcast receiving apparatus receives and executes an application that a broadcast station transmits a predetermined time period (five minutes, for example) before the start of multi-channel broadcasting. In accordance with the application, the digital broadcast receiving apparatus displays a listing of preview images of the programs.

### TECHNICAL FIELD

The present invention relates to a digital broadcast receiving apparatus, and especially to multi-channel broadcasting technology.

### BACKGROUND ART

Recent digital broadcasting technology provides multi-channel broadcasting services. The multi-channel broadcasting service is based on the capability of simultaneously broadcasting up to three standard definition television (SDTV) programs on a single high definition television (HDTV) channel. In the service, one broadcast station simultaneously broadcasts two or three different SDTV programs, rather than one HDTV program.

Some apparatus capable of receiving multi-channel broadcasting simultaneously display received programs on a split screen.

One undesirable possibility involved in multi-channel broadcasting is that a user may fail to appropriately record a program of his interest unless the user is informed of each of a plurality of available programs in advance. Further, it is also likely that a user misses a program of his interest because the user is not aware that the program is broadcast on one of the multi-channels.

In view of the above problems, the present invention aims to provide a digital broadcast receiving apparatus capable of informing users about multi-channel broadcasting of programs before the broadcasting starts.

### DISCLOSURE OF THE INVENTION

To achieve the above aim, the present invention provides a digital broadcast receiving apparatus for receiving multi-channel broadcasting of programs. Note that the multi-channel broadcasting refers to parallel transmission of a plurality of programs within a frequency bandwidth allocated for a single HDTV channel. The digital broadcast receiving apparatus according to the present invention includes: a receiving unit operable to receive a broadcast wave on an HDTV channel; an information acquiring unit operable to acquire, a predetermined time period before a start of multi-channel broadcasting on the HDTV channel, pieces of program information in one-to-one relation with programs to be broadcast; a display unit operable to display the acquired pieces of program information; a viewing program selecting unit operable to select one of the displayed pieces of program information; and a reproducing unit operable to reproduce a program corresponding to the selected piece of program information. The predetermined time period mentioned herein is provided for allowing the user to be aware of the scheduled multi-channel broadcasting and to check through the program information. The predetermined time period may be five to ten minutes.

With the structure stated above, the digital broadcast receiving apparatus is enabled to acquire and display, prior to the start of multi-channel broadcasting, information about each of a plurality of programs scheduled to be multi-channel broadcast. Since the acquired pieces of program information are displayed the predetermined time period before the multi-channel broadcasting, the user is allowed to make operations necessary for viewing a program with reference to the program information. Thus, it can be avoided that the user misses a program of his interest. In addition, one of programs broadcast on multi-channels is selected to be reproduced in response to a user selection of a piece of program information displayed. That is to say, the user can select any of the programs on multi-channels without going through complicated operations on a remote controller.

Here, the digital broadcast receiving apparatus may further include: a recording program selecting unit operable to select one of the displayed pieces of program information; and a recording unit operable to record a program corresponding to the piece of program information selected by said recording program selecting unit, from a broadcast start time of the program.

With the structure stated above, one of programs broadcast on multi-channels is selected to be recorded in response to a user selection of a piece of program information displayed. That is, record setting can be made with reference to the program information, prior to the start of multi-channel broadcasting. Thus, even if the user has forgotten about that multi-channel broadcasting is scheduled, the digital broadcast receiving apparatus informs the user about the multi-channel broadcasting. This helps the user to record a program of his interest, without fail.

Here, the digital broadcast receiving apparatus may further include a recording unit operable to record one of the programs corresponding to program information not selected by said viewing program selecting unit.

With this structure, it is allowed to record one of the programs on the multi-channels, other than the program the user is watching. Thus, the user can view the recorded program at a later time.

Here, the information acquiring unit may acquire the program information overlaid on a broadcast transport stream received by the receiving unit.

With this structure, the program information may be acquired via a broadcast wave. In digital broadcasting, it is possible to broadcast, in addition to program contents, data such as copy control information by overlaying the data on a transport stream. Taking advantage of this technical feature, the digital broadcast apparatus acquires the program information overlaid on the transport stream.

Here, the digital broadcast receiving apparatus may further include a storage unit operable to store in advance an electric program guide. The information acquiring unit may acquire the program information from the electric program guide.

With the structure stated above, the program information is acquired from an EPG (Electronic Program Guide) stored in the digital broadcast apparatus. Thus, even if no program information is transmitted from the broadcast station, the digital broadcast apparatus is enabled to perform necessary processing.

Here, the digital broadcast receiving apparatus may further include a detecting unit operable to detect an end of the program being recorded by the recording unit. The recording unit may continue the recording until the detecting unit detects the end of the program.

With the structure stated above, it is ensured to extend recording of a program when necessary. Thus, it is avoided that a user requested program is incompletely recorded.

Here, the digital broadcast receiving apparatus may further include a channel switchover unit operable to switch sub-channels within the HDTV channel upon detecting, before the detecting unit detects the end of the program, that the broadcast of the currently recorded program is scheduled to be switched from one sub-channel to another sub-channel.

With the structure stated above, it is ensured to continuously record a program even if the sub-channel of the program is switched to another sub-channel when multi-channel broadcasting starts due to the extended broadcast of the program.

Here, each piece of program information may be a preview image of a corresponding program.

With the structure stated above, preview images of programs are used to inform the user that multi-channel broadcasting of the programs is about to start. In addition, the preview images serve to inform the contents of the programs.

Here, each piece of program information may be text data indicating contents of a corresponding program.

With the structure stated above, text data, such as comments about programs, stored in the EPG is used to inform the user that multi-channel broadcasting of programs is about to start. In addition, the text data serve to inform the contents of the programs.

Here, each piece of program information may be a still image of a scene of a corresponding program.

With the structure stated above, still images of programs are used to inform the user that multi-channel broadcasting of programs is about to start. In addition, the still images serve to inform the contents of the programs.

Here, when a program originally scheduled to be broadcast subsequently to the currently reproduced program is set in advance to be recorded, and the currently reproduced program is broadcast beyond an originally scheduled time in parallel with the subsequent program, the recording unit may start to record the subsequent program, instead of the program corresponding to the piece of program information selected by the recording program selecting unit. The detecting unit may start to detect an end of the program being reproduced, instead of an end of the program being recorded by the recording unit. The reproduction unit may start to reproduce the subsequent program recorded by the recording unit from a beginning, upon detection of the program end by the detecting unit.

With the structure stated above, in the case where the broadcast of a program that the user is currently watching is extended and a program originally scheduled to be broadcast subsequently to the current program has been set to be recorded, it is ensured that so-called chase playback of the recorded program starts upon the end of the program the user is watching.

Here, the digital broadcast receiving apparatus according may further include: a record presetting unit operable to be set in advance to record a program according to a user input; a recording unit operable to record the program set by the record presetting unit; a detecting unit operable to detect an end of the program being recorded by the recording unit; and a channel switchover unit operable to switch sub-channels within the HDTV channel, in synchronization with a switchover of a sub-channel on which the currently recorded program is broadcast to another sub-channel. When the program being recorded by the recording unit is broadcast beyond an originally scheduled time in parallel with a program originally scheduled to be subsequently broadcast, the information acquiring unit may acquire program information of both the programs. The channel switchover unit may switch the sub-channels, so that the recording unit continuously records the same program before and after the sub-channel switchover. The recording unit may continue the recording until the detecting unit detects the end of the program.

With the structure stated above, even in the case where the broadcast of a program is extended and the program has been set by the user to be recorded, the preset program is recorded appropriately.

In another aspect, the present invention provides a processing method of multi-channel broadcast programs, for use by a digital broadcast receiving apparatus that receives multi-channel broadcasting of programs. Note that the multi-channel broadcasting refers to parallel transmission of a plurality of programs within a frequency bandwidth allocated for a single HDTV channel. The processing method according to the present invention includes: receiving a broadcast wave on an HDTV channel; acquiring, a predetermined time period before a start of multi-channel broadcasting on the HDTV channel, pieces of program information in one-to-one relation with programs to be broadcast; displaying the acquired pieces of program information; selecting one of the displayed pieces of program information; and reproducing a program corresponding to the selected piece of program information, from a broadcast start time of the program.

In yet another aspect, the present invention provides a computer-readable processing program of multi-channel broadcast programs, for execution on a digital broadcast receiving apparatus that receives multi-channel broadcasting of programs. Note that the multi-channel broadcasting refers to parallel transmission of a plurality of programs within a frequency bandwidth allocated for a single HDTV channel. The computer-readable processing program according to the present invention includes code operable to cause the digital broadcast receiving apparatus to: receive a broadcast wave on an HDTV channel; acquire, a predetermined time period before a start of multi-channel broadcasting on the HDTV channel, pieces of program information in one-to-one relation with programs to be broadcast; display the acquired pieces of program information; select one of the displayed pieces of program information; and reproduce a program corresponding to the selected piece of program information, from a broadcast start time of the program.

With the method and program stated above, a digital broadcast receiving apparatus is enabled to acquire, in advance, information about programs scheduled to be multi-channel broadcast, and to perform appropriate processing based on the acquired information. To display the acquired information is one example of such processing.

In yet another aspect, the present invention provides integrated circuit for use on a digital broadcast receiving apparatus that receives multi-channel broadcasting of programs. Note that the multi-channel broadcasting refers to parallel transmission of a plurality of programs within a frequency bandwidth allocated for a single HDTV channel. The integrated circuit according to the present invention includes: a receiving module operable to receive a broadcast wave on an HDTV; an information acquiring module operable to acquire, a predetermined time period before a start of multi-channel broadcasting on the HDTV channel, pieces of program information in one-to-one relation with programs to be broadcast; a display module operable to display the acquired pieces of program information; a viewing program selecting module operable to select one of the displayed pieces of program information; and a reproducing module operable to reproduce a program corresponding to the selected piece of program information, from a broadcast start time of the program.

By incorporating the integrated circuit, a digital broadcast receiving apparatus is enabled to acquire, in advance, information about programs scheduled to be multi-channel broadcast, and to perform appropriate processing based on the acquired information. To display the acquired information is one example of such processing.

### BRIEF DESCRIPTION OF THE DRAWINGS

FIG. 1 is a functional block diagram of a digital broadcast receiving apparatus according to an embodiment 1 of the present invention;

FIG. 2 is a view showing part of program guide information relating to a broadcast station A, according to the embodiment 1;

FIG. 3 is a view showing structure of data received by the digital broadcast receiving apparatus;

FIG. 4 is a view showing an example of display screen presented on a display before the start of multi-channel broadcasting;

FIG. 5 is a view showing an example of display screen presented on the display before the start of multi-channel broadcasting;

FIG. 6 is a view showing an example of display screen presented on the display before the start of multi-channel broadcasting;

FIG. 7 is a view showing an example of display screen presented on the display before the start of multi-channel broadcasting;

FIG. 8 is a view showing an example of display screen presented on the display before the start of multi-channel broadcasting;

FIG. 9 is a flowchart of operating steps performed by the digital broadcast receiving apparatus before the start of multi-channel broadcasting, for displaying preview images;

FIG. 10 is a flowchart of operating steps performed by the digital broadcast receiving apparatus after displaying the preview images;

FIG. 11 is a functional block diagram of a digital broadcast receiving apparatus according to an embodiment 2 of the present invention;

FIG. 12 is a flowchart of operating steps performed by the digital broadcast receiving apparatus, for starting an application to display preview images;

FIGS. 13A and 13B are views showing program guide tables relating a broadcast station according to an embodiment 4 of the present invention;

FIG. 14 is a view showing an example of display screen presented on a display before the start of multi-channel broadcasting;

FIG. 15 is a view showing an example of display screen presented on the display before the start of multi-channel broadcasting;

FIG. 16 is a view showing an example of display screen presented on the display before the start of multi-channel broadcasting;

FIG. 17 is a view showing an example of EPG; and

FIG. 18 is a flowchart of operating steps performed by the digital broadcast receiving apparatus for recording a program, in the case where a broadcast of a program is extended.

### BEST MODE FOR CARRYING OUT THE INVENTION

### Embodiment 1

With reference to the accompanying drawings, the following describes a digital broadcast receiving apparatus according to an embodiment 1 of the present invention and also describes a broadcast station.

<Overview>

The digital broadcast receiving apparatus according to the embodiment 1 receives preview images transmitted from a broadcast station a predetermined time period (five minutes, for example) before the start of multi-channel broadcasting. The digital broadcast receiving apparatus then displays a listing of the preview images. With the preview images, users are informed that multi-channel broadcasting is about to start. In addition, the users are informed of the contents of programs scheduled to be broadcast on the multi-channels.

<Structure>

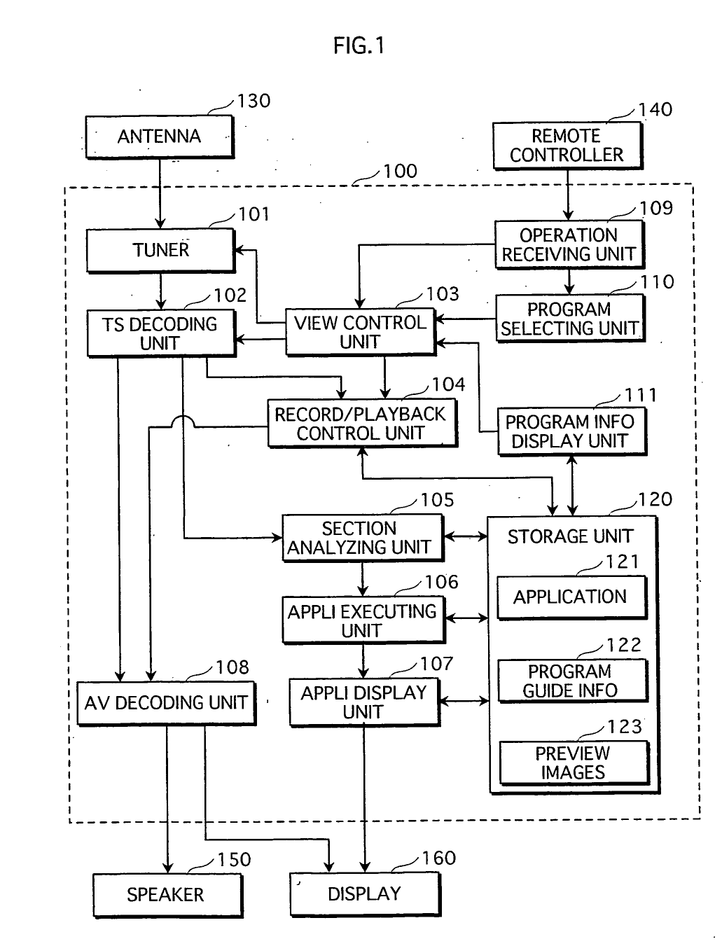

FIG. 1 is a functional block diagram of a digital broadcast receiving apparatus 100 according to the embodiment 1. Hereinafter, a description is given to functional blocks of the digital broadcast receiving apparatus 100, with reference to FIG. 1.

The digital broadcast receiving apparatus 100 is composed generally of a tuner 101, a TS decoding unit 102, a view control unit 103, a record/playback control unit 104, a section analyzing unit 105, an appli executing unit 106, an appli display unit 107, an ΔV decoding unit 108, an operation receiving unit 109, a program selecting unit 110, a program information display unit 111, and a storage unit 120.

In addition, the digital broadcast receiving apparatus 100 is connected to: an antenna 130 for receiving a broadcast; a remote controller 140 for a user to input instructions to the digital broadcast receiving apparatus 100; a speaker 150 for output of audio generated by the digital broadcast receiving apparatus 100; and a display 160 for displaying video generated by the digital broadcast receiving apparatus 100.

The tuner 101 functions to receive, via the antenna 130, a transport stream (TS) on a channel specified by the view control unit 103 and output the received TS to the TS decoding unit 102.

The TS decoding unit 102 functions to filter a TS received from the tuner 101, and output resulting data to the AV decoding unit 108 and the section analyzing unit 105.

The view control unit 103 functions to control the tuner 101, so that a TS transmitted on a user-selected channel specified by an output of the program selecting unit 110 is received. The view control unit 103 also functions to control the TS decoding unit 102, so that the received TS is decoded and outputted to the AV decoding unit 108 and the section analyzing unit 105.

The record/playback control unit 104 functions to control the storage unit 120 in accordance with a record instruction that is issued by the view control unit 103 in response to a user input received via the operation receiving unit 109. Under the control, the storage unit 120 records a currently receiving broadcast. Record instructions from a user include an instruction for preset recording. When a recording is preset, the setting is stored in the storage unit 120, so that recording of a requested program automatically starts at a set time.

The section analyzing unit 105 functions to extract data for use by an application, from AV data resulting from the filtering by the TS decoding unit 102.

The appli executing unit 106 functions to read and execute an application 121 temporarily stored in the storage unit 120. The execution of the application 121 is started in response to an application start code transmitted on a broadcast wave from the broadcast station five minutes before the start of multi-channel broadcasting. In according with the application, the appli executing unit 106 outputs data necessary for displaying preview images to the appli display unit 107. Each time multi-channel broadcasting is performed, a new application is transmitted on a broadcast wave from the broadcast station and the storage unit 120 stores the application. Note that each application is received only if the application relates to multi-channel broadcasting from the same broadcast station that transmits a TS being received by the tuner 101.

The appli display unit 107 functions to generate, using data generated by the appli executing unit 106, a GUI (Graphical User Interface) for displaying preview images in list form, and output the generated GUI to the display 160.

The AV decoding unit 108 functions to decode AV data resulting from filtering by the TS decoding unit 102, and output decoded audio data to the speaker 150 and decoded video data to the display 160.

The operation receiving unit 109 functions to receive, via the remote controller 140, user inputs relating to a channel selection and a program recording, and issue a corresponding instruction to the view control unit 103 and the program selecting unit 110.

The program selecting unit 110 functions to select a channel of a program selected by the user via the operation receiving unit 109. In addition, when the user selects one of preview images of programs displayed prior to the multi-channel broadcasting, the program selecting unit 110 functions to select a channel of a program corresponding to the selected preview image at a broadcast start time of the program, and outputs information indicating the selected channel to the view control unit 103.

The program information display unit 111 functions to generate data for displaying information relating to programs scheduled to be broadcast on multi-channels and output the resulting data to the view control unit 103. The data is generated from program guide information stored in the storage unit 120 in the case where no preview images are acquired from the broadcast station.

The storage unit 120 may be implemented by an HDD or memory of various types, and functions to store various data. Specifically, the storage unit 120 stores the application 121, program guide information 122, and preview images 123. The application 121 is a program for displaying a preview image listing. The program guide information 122 is an EPG (Electronic Program Guide) that the digital broadcast receiving apparatus 100 has acquired in advance. Each preview image 123 visually represents the contents of a program scheduled to be broadcast on one of multi-channels and received from the broadcast station a predetermined time period before the start of multi-channel broadcasting. The storage unit 120 also functions to store a program recorded by the record/playback control unit 104. In addition, the storage unit 120 functions to make read and write accesses to recording media typified by optical discs, such as DVDs (Digital Versatile Discs) and BDs (Blu-ray Discs).

<Data>

Hereinafter, a description is given to data relating to the digital broadcast receiving apparatus 100.

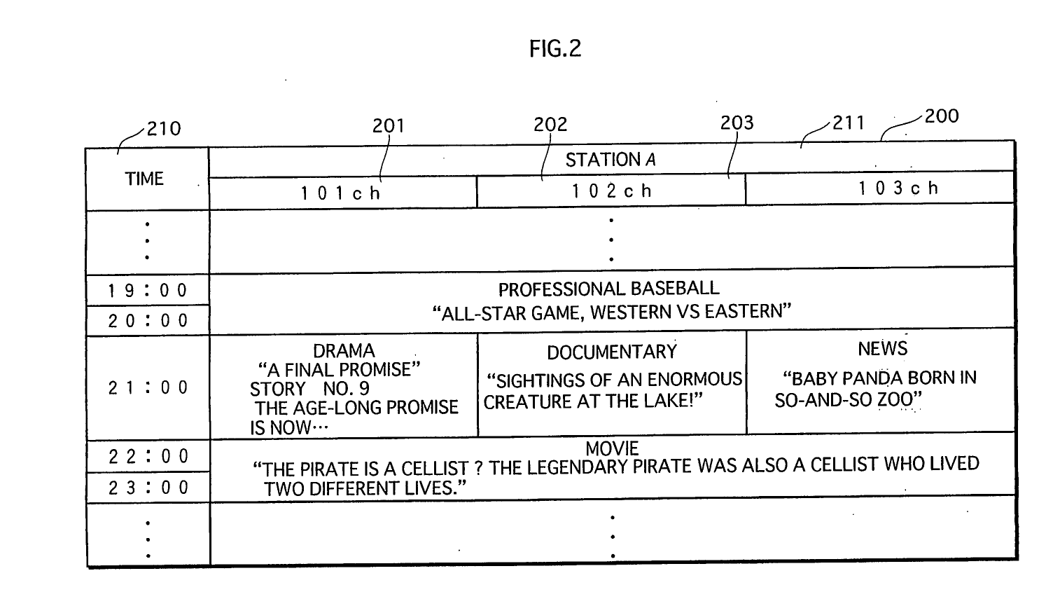

FIG. 2 shows, as an example, part of the program guide information 122, which in this case is an EPG relating to programs scheduled to be broadcast from a broadcast station A. It is naturally appreciated that the storage unit 120 also stores program guide information relating to programs of broadcast stations other than the broadcast station A.

The program guide information 122 is composed of information regarding a time 210, a broadcast station name 211, sub-channels 101ch, 102ch, and 103ch, which are denoted by reference numerals 201, 202, and 203, respectively. The time 210 shows the broadcast start time of each program. The broadcast station name 211 shows the name of the broadcast station, which in this example is the broadcast station A. The sub-channels 201-203 are channels allocated to the broadcast station A. On the three sub-channels, the broadcast station A is allowed to broadcast one HDTV program. The program guide information 122 also includes information about the category, title, and contents of each program in association with a corresponding sub-channel and time slot.

As shown in FIG. 2, for two hours from 19:00 to 21:00, a professional baseball “All-Star Game, Western vs. Eastern” is scheduled to be broadcast in high vision. From 21:00 to 22:00, multi-channel broadcasting is scheduled. In that time slot, the following three different programs are scheduled to be broadcast: a drama called “Final Promise, Story No. 9”; a documentary; and a news program. From 22:00, a movie called “The Pirate is a Cellist” is scheduled to be broadcast in high vision.

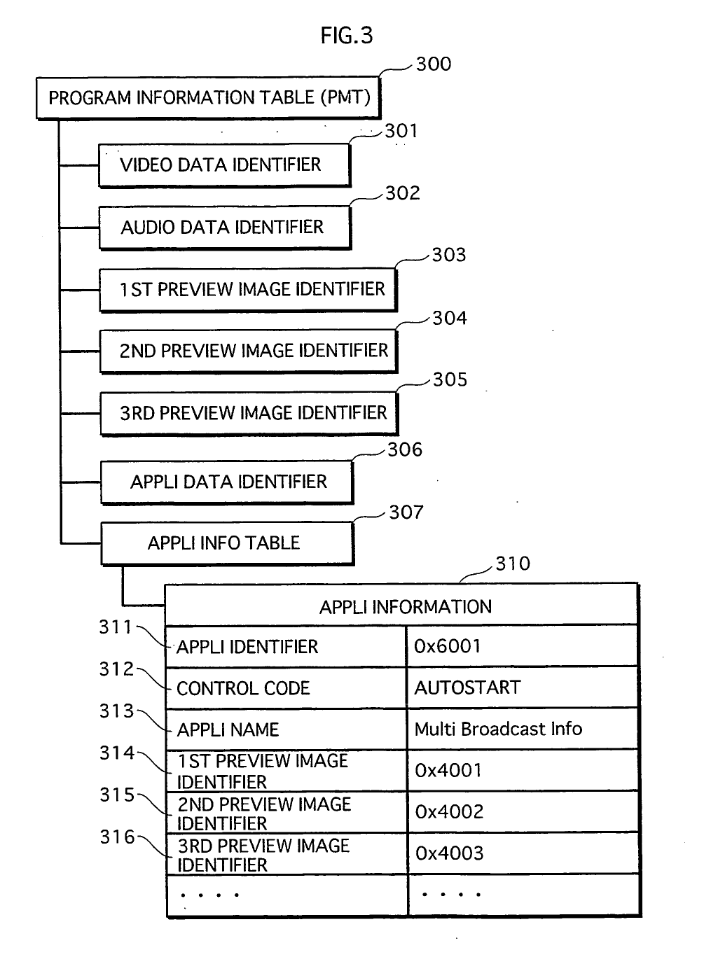

FIG. 3 is a view of a program information table 300 shows the structure of data carried by a broadcast wave received by the digital broadcast receiving apparatus 100, particularly the structure of data relating to the application.

As shown in FIG. 3, data that the digital broadcast receiving apparatus 100 receives via a broadcast wave includes a video data identifier 301, an audio data identifier 302, a first preview image identifier 303, a second preview image identifier 304, a third preview image identifier 305, an appli data identifier 306, and an appli information table 307.

Each identifier uniquely identifies a corresponding piece of data. In the broadcast wave, each piece of data is headed by a corresponding identifier. Consequently, the section analyzing unit 105 is allowed to separate specific pieces of data from the broadcast wave. Data headed by the video data identifier 301 and the audio data identifier 302 constitutes a program being broadcast. In this way, the section analyzing unit 105 is allowed to judge which data is to be outputted to the appli executing unit 106 and which data is not.

The appli information table 307 includes appli information 310. The appli information 310 includes an appli identifier 311, a control code 312, an appli name 313, a first preview image identifier 314, a second preview image identifier 315, and a third preview image identifier 316.

The appli identifier 311 is used by the section analyzing unit 105 to identify an application carried on a broadcast wave.

The control code 312 indicates how the application is started. In this example, the control code 312 indicates “Auto Start”, which means that the application is executed by the appli executing unit 106 substantially immediately when the application is received.

The appli name 313 is a name of the application to be executed by the appli executing unit 106. The application name is predetermined by the broadcast station.

The first, second, and third preview image identifiers 314-316 each identify a preview image. With the use of preview image identifiers 314-316, the appli executing unit 106 is allowed to identify specific preview images to be used during execution of the application.

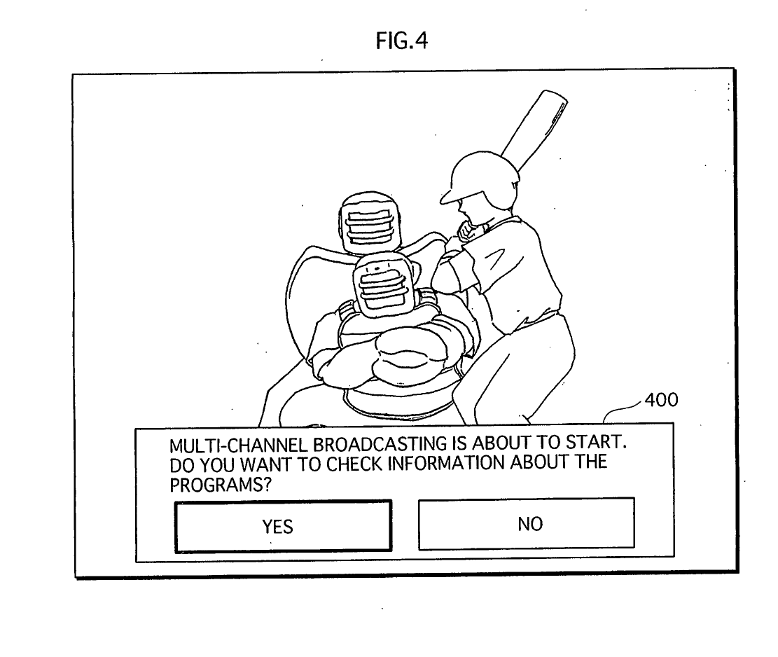

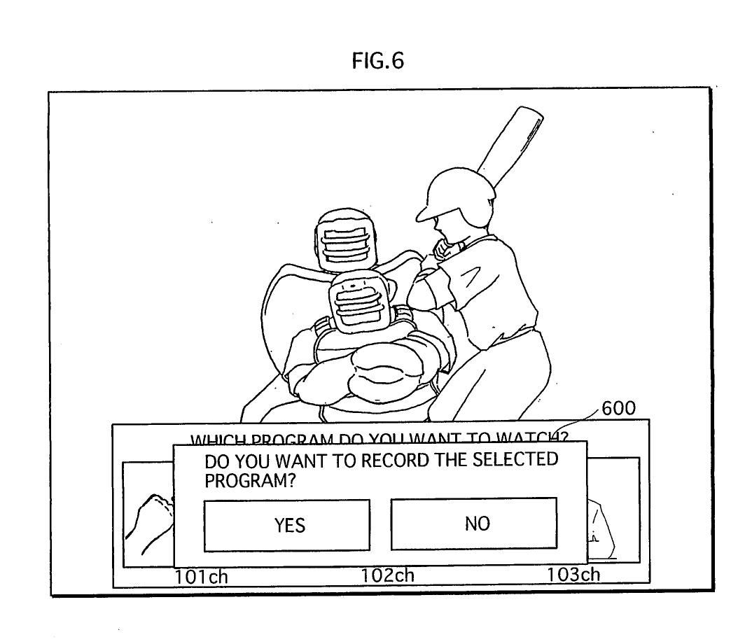

FIGS. 4-8 show display screens presented on the display 160 connected to the digital broadcast receiving apparatus 100, at the start of multi-channel broadcasting. Explanations of each display screen will be given in relation to associated operating steps performed by the digital broadcast receiving apparatus 100.

<Operation>

The digital broadcast receiving apparatus 100 receives and displays broadcast programs basically in the same manner as a conventional digital television. Thus, no description is given to such operating steps. A description hereinafter is given to operating steps performed by the digital broadcast receiving apparatus 100, in relation to multi-channel broadcasting.

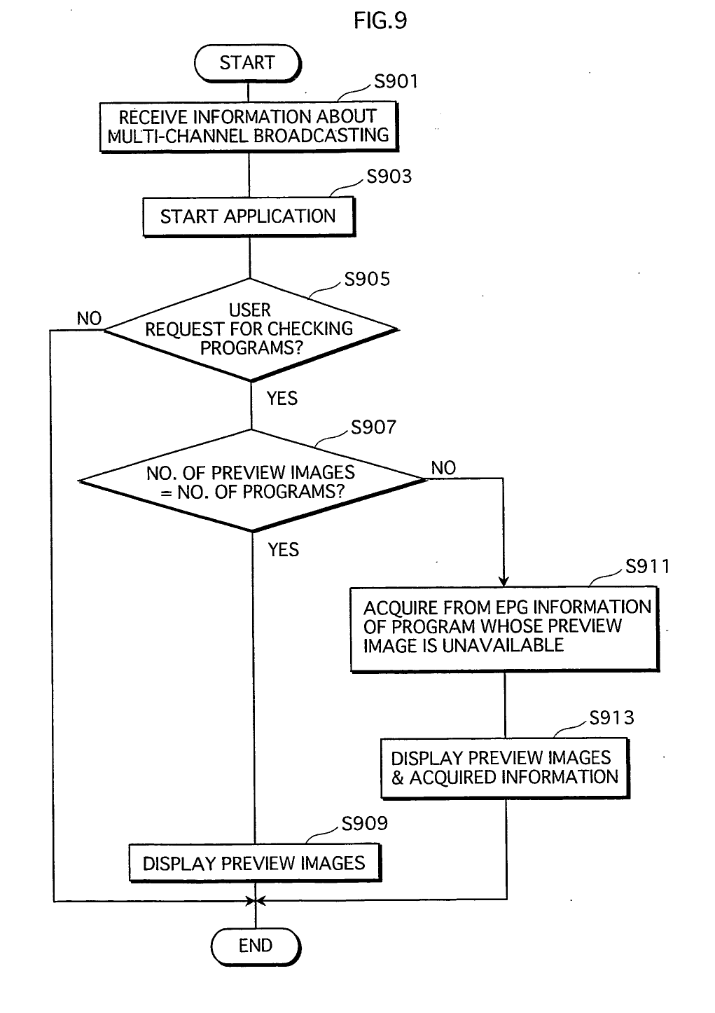

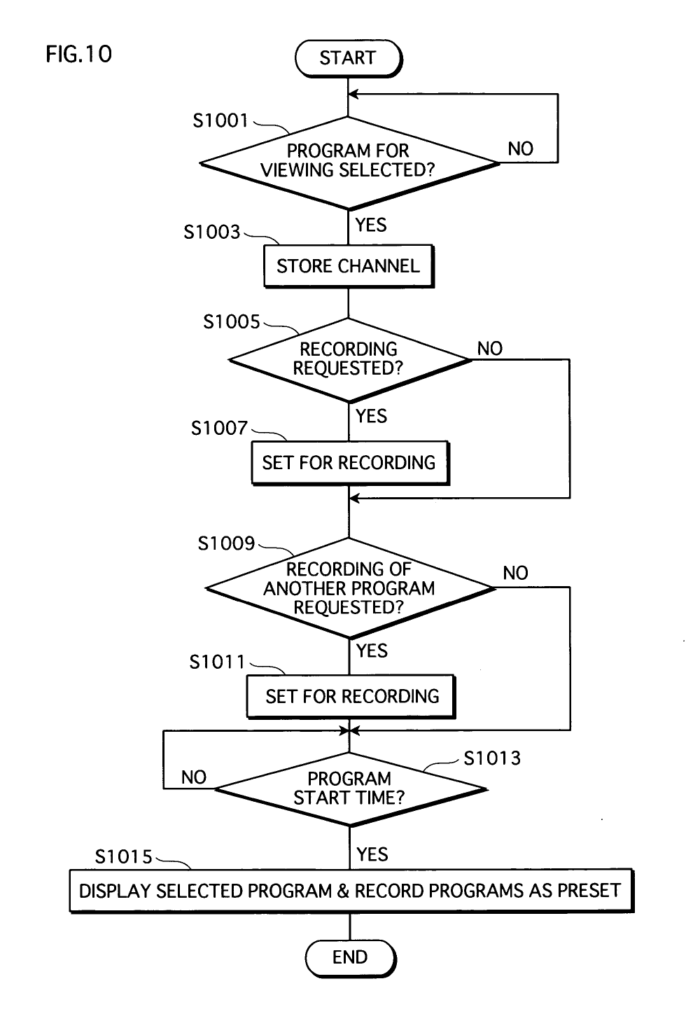

Now, a description is given to operating steps performed by the digital broadcast receiving apparatus 100 at the start of multi-channel broadcasting. In the description, reference is made to flowcharts show in FIGS. 9 and 10.

In this example, the digital broadcast receiving apparatus 100 is receiving a broadcast program from the broadcast station A, and presenting the program on the display 160.

First, a description is given to operating steps for displaying preview images, with reference to the flowchart shown in FIG. 9.

The digital broadcast receiving apparatus 100 receives, from the broadcast station A, information including an application and indicating that multi-channel broadcasting will start (step S901). The information is received a predetermined time period (five minutes, for example) before the start of multi-channel broadcasting, so as to allow the user enough time to check the contents of programs to be broadcast. Upon receipt of the information, the appli executing unit 106 starts the application overlaid on the TS (step S903). In accordance with the application, the digital broadcast receiving apparatus 100 displays a GUI indicating that multi-channel broadcasting is about to start, and prompts the user to make an input as to whether the user desires to check the contents of programs scheduled to be broadcast (step S905). If the user selects “NO” using the remote controller 140 (step S905, NO), the digital broadcast receiving apparatus 100 simply turns off the GUI from the display screen. Thus, the program the user is currently viewing remains on the display screen.

On the other hand, if the user selects “YES” (step S905, YES), the digital broadcast receiving apparatus 100 reads, from the storage unit 120, preview images having been transmitted on a broadcast wave from the broadcast station A. If the number of read preview images is equal to the number of programs scheduled to be broadcast (step S907, YES), the digital broadcast receiving apparatus 100 displays a GUI presenting preview images (step S909). The GUI is generated by rendering each preview image in a predetermined rendering region. On the other hand, if the number of preview images is not equal to the number of programs, the digital broadcast receiving apparatus 100 reads, from the EPG, text data relating to each program of which preview image is not available (step S910). Then, the digital broadcast receiving apparatus 100 then displays a GUI showing the read text data in an appropriate region, along with each available preview image of other programs (step S911). That is, the GUI shows information of every program scheduled to be broadcast, either with text data or preview image.

Next, a description is given to operating steps after displaying the preview images, with reference to the flowchart shown in FIG. 10.

First, the remote controller 140 receives a user input selecting a program for viewing, i.e. selecting one of preview images displayed (step S1001, YES). In response, the storage unit 120 stores a channel of the program corresponding to the selected preview image (step S1003). The digital broadcast receiving apparatus 100 stays in a standby mode until a user selection of a program is made (step S1001, NO).

Next, the digital broadcast receiving apparatus 100 displays a GUI prompting the user to input whether to record the selected program. If the user responds by requesting to record the program (step S1005, YES), the record/playback control unit 104 makes record presetting accordingly (step S1007). On the other hand, if the user does not request to record the program (step S1005, NO), the processing goes onto a step S1009.

In the step S1009, the digital broadcast receiving apparatus 100 displays a GUI prompting the user to input whether to record another program. If the user requests, via the remote controller 140, to record another program (step S1009, YES), the digital broadcast receiving apparatus 100 receives a user selection of a program to be recorded. The record/playback control unit 104 makes record presetting according to the user selection (step S1011).

At the broadcast start time of the selected program (step S1013, YES), the program selecting unit 110 selects a program broadcast on the selected channel stored in the storage unit 120. The record/playback control unit 104 records the program according to the stored presetting (step S1015). This completes the processing.

On viewing the GUI presenting preview images of programs scheduled to be broadcast, the user selects a program that the user desires to watch, by moving a cursor to a corresponding preview image with the remote controller 140. On receiving the user selection via the remote controller 140, the digital broadcast receiving apparatus 100 stores information indicating the channel of the selected program. Next, the digital broadcast receiving apparatus 100 displays a GUI prompting for an input as to whether the selected program is to be recorded.

At the broadcast start time of the selected program, the digital broadcast receiving apparatus 100 switches a current channel to the channel on which the selected program is broadcast. This completes the processing.

Now, the above operating steps are described using a specific example. Suppose, the time is now 20:45, and the user is watching the professional baseball “All-Star Game, Western vs. Eastern”, as shown in the program guide table of FIG. 2. At 22:55, the program information table 300 is transmitted from the broadcast station. The program information table 300 is overlaid on the TS carrying a broadcast program, so that the digital broadcast receiving apparatus 100 receives the program information table 300 with the TS. As shown in FIG. 3, the program information table 300 includes an application and preview images to be displayed during execution of the application. Also as shown in FIG. 3, the application is set to automatically start (Auto Start) immediately upon receipt by the digital broadcast receiving apparatus 100.

As described above, the program information table 300 includes a start code for the application. The appli executing unit 106 thus reads and starts the application 121 once stored to the storage unit 120. Through execution of the application 121, first, the appli display unit 107 displays a GUI 400, as shown in FIG. 4. The GUI 400 informs the user that multi-channel broadcasting is about to start, and prompts for an input as to whether the user desires to check the contents of programs to be multi-channel broadcast.

On viewing the GUI 400, the user inputs whether to check the contents of programs with the remote controller 140. In this example, it is assumed that the user selects to check the contents of the programs.

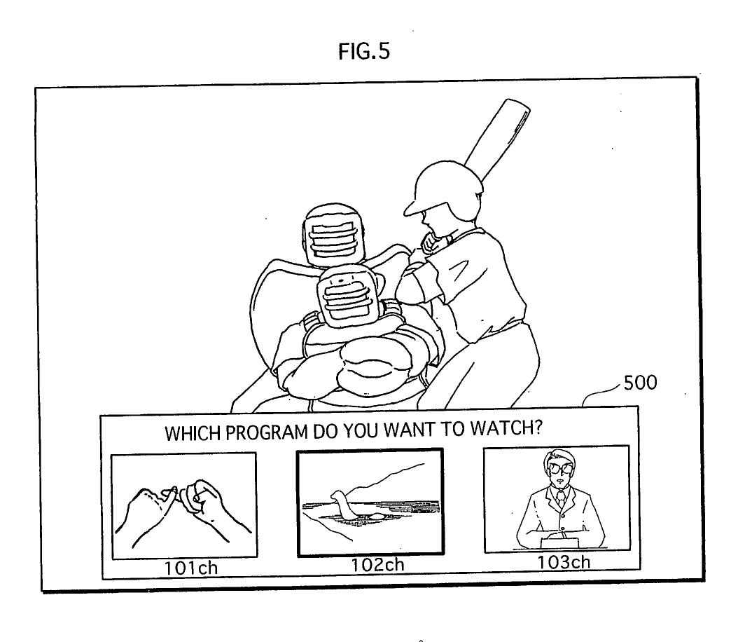

Next, in accordance with the application, the appli executing unit 106 reads preview images of the programs scheduled to be broadcast from the storage unit 120. The appli executing unit 106 then instructs the appli display unit 107 to display the read preview images as part of a GUI 500 as shown in FIG. 5. Specifically, the appli display unit 107 displays the three preview images at the bottom of the display screen so as not to obstruct display of the baseball game, which is a main broadcast. The GUI 500 prompts the user to select one of the preview images corresponding to a program that the user desires to watch. As shown in the figure, the GUI 500 displays a currently selected preview image within a heavy-line box (as the preview image for 102ch). The heavy-line box moves in response to user operations made to arrow keys on the remote controller 140. At a push of an enter key, the selection is entered, so that a program to be displayed from 21:00 is determined. When the selection is entered, the channel for the program corresponding to the user-selected preview image is temporarily stored to the storage unit 120. However, a channel is not switched at this stage because the broadcast start time of the program has not come yet.

After the program selection, the appli display unit 107 displays a GUI 600 prompting the user for an input as to whether the selected program is requested to be recorded. As shown in FIG. 5, the GUI 600 is overlaid on the GUI 500. In response to the GUI 600, the user makes an input with the remote controller 140 as to whether the recording is requested.

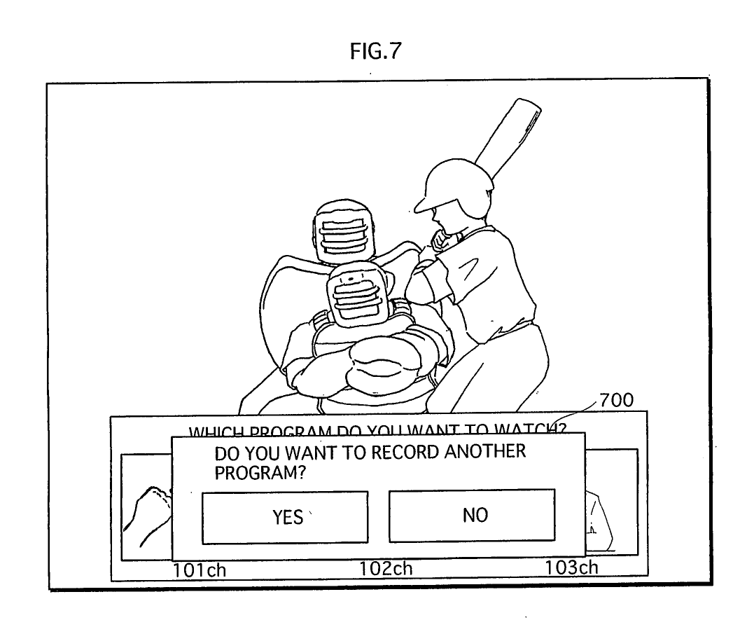

Next, the appli executing unit 106 generates data for displaying a GUI 700 prompting the user for an input as to whether another program is requested to be recorded. The appli display unit 107 then displays the GUI 700 shown in FIG. 7, using the thus generated data.

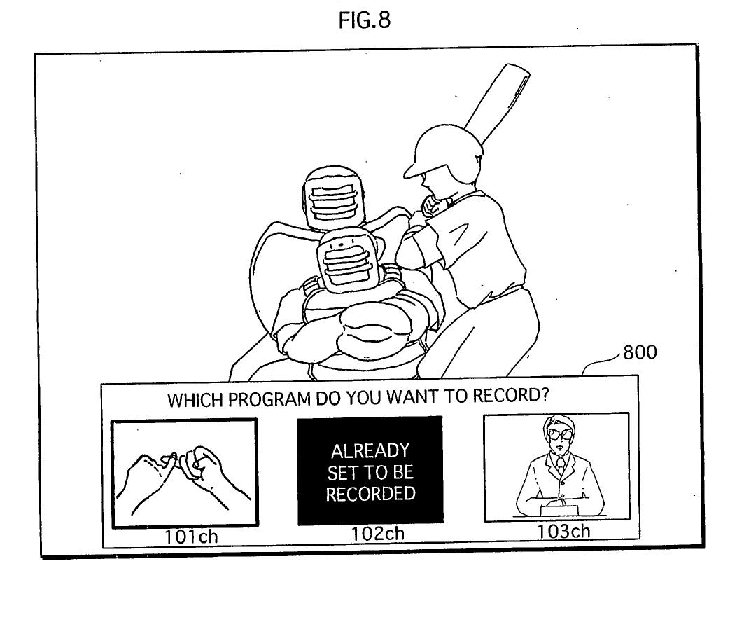

If the user selects to record another program, the appli executing unit 106 generates data for displaying a GUI 800 prompting the user to additionally select a program to be recorded, and displays the GUI 800 shown in FIG. 8. In response, the user makes the selection of program to be recorded.

At the broadcast start time of the selected program, the digital broadcast receiving apparatus 100 displays the selected program on the display 160. If any program is preset to be recorded, the digital broadcast receiving apparatus 100 records the preset program.

### Embodiment 2

In the embodiment 1 described above, the digital broadcast receiving apparatus 100 starts an application that is transmitted from the broadcast station together with preview images. In an embodiment 2 of the present invention, the application is started in a different way. Hereinafter, a description is given to differences with the first embodiment.

<Structure>

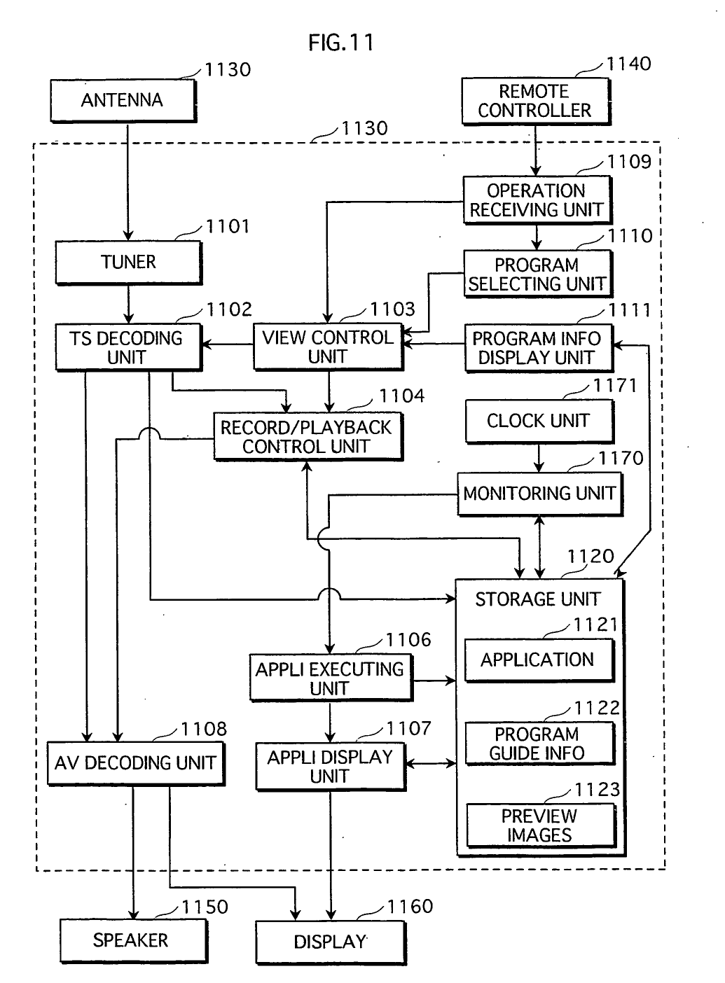

FIG. 11 is a functional block diagram of a digital broadcast receiving apparatus 1100 according to the embodiment 2. The digital broadcast receiving apparatus 1100 differs from the digital broadcast receiving apparatus 100 of the embodiment 1 in that a monitoring unit 1170 and a clock unit 1171 are additionally provided.

The monitoring unit 1170 functions to constantly monitor program guide information 1122, i.e. an EPG, stored in a storage unit 1120. By monitoring the program guide information 1122, the monitoring unit 1170 checks whether multi-channel broadcasting is scheduled.

In addition, the monitoring unit 1170 functions to acquire a current date and time from the clock unit 1171. If it is detected that multi-channel broadcasting is scheduled, the monitoring unit 1170 instructs an appli executing unit 1106 to start the application five minutes before the start of the multi-channel broadcasting.

Upon receipt of the instruction from the monitoring unit 1170, the appli executing unit 1106 reads and executes the application 1121 stored in the storage unit 1120. In the embodiment 1 described above, an application is transmitted on a broadcast wave five minutes before the start of multi-channel broadcasting, and the application is automatically started immediately upon receipt. In the embodiment 2, the appli executing unit 1106 executes the application stored in advance, in response to an instruction from the monitoring unit 1170.

The clock unit 1171 is a time-of-day clock, and constantly outputs the current date and time to the monitoring unit 1170.

The storage unit 1120 stores the application 1121 in advance. The application 1121 is used for displaying a listing of preview images, and is basically identical in data content to the application 121 of the first embodiment. Note, however, the application 1121 is not provided with preview images used to constitute GUIs. The digital broadcast receiving apparatus 1100 acquires preview images of programs scheduled to be broadcast on one of multi-channels, by five minutes before the start of the multi-channel broadcasting at the latest. The application 1121 is executed in conjunction with the thus acquired preview images.

<Data>

The storage unit 1120 stores the application 1121 in advance. The application 1121 is read and executed by the appli executing unit 1106. The application 1121 is provided with basic data necessary for presenting GUIs upon multi-channel broadcasting. The application 1121 is designed to present GUIs by appropriately laying out preview images acquired by the digital broadcast receiving apparatus 1100.

In addition, the storage unit 1120 stores a program guide table 200 shown in FIG. 2 as program guide information 1122. The program guide information 1122 includes identifiers for preview images of programs scheduled to be broadcast on multi-channels. With the use of the identifiers, the appli executing unit 1106 identifies specific preview images required.

In the case where multi-channel broadcasting is scheduled, the storage unit 1120 acquires preview images used for presenting to the user the contents of program to be broadcast, by five minutes before the multi-channel broadcasting at the latest. In this embodiment, the broadcast station collectively transmits a set of preview images for a day, and each preview image is deleted from the storage unit 1120 after the start of a program to which the preview image relates. With this arrangement, it is avoided that a number of preview images occupy too much capacity of the storage unit 1120.

<Operation>

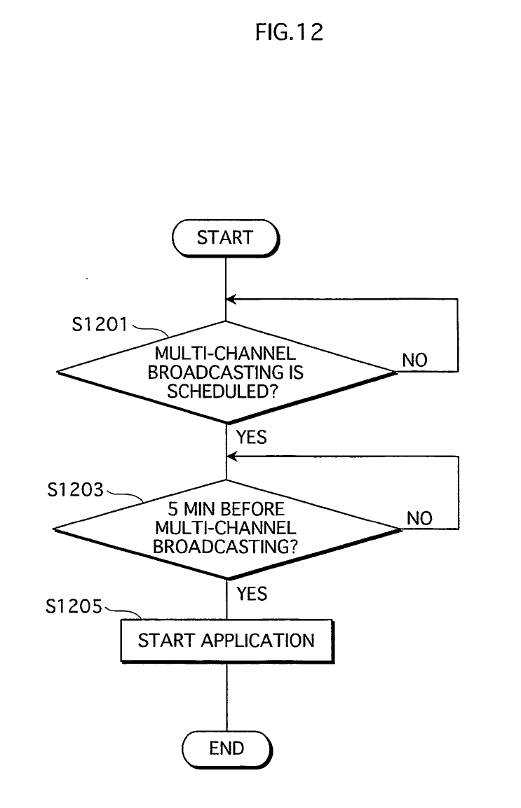

FIG. 12 is a flowchart of operating steps performed by the digital broadcast receiving apparatus 1100 for starting the application 1121. With reference to the flowchart, the operation of the digital broadcast receiving apparatus 1100 is described, with the focus on differences with the embodiment 1. The description overlapping the embodiment 1 is not repeated here.

First, the monitoring unit 1170 constantly monitors the program guide information 1122, i.e. the EPG. More specifically, the monitoring unit 1170 monitors where a program subsequent to the program being broadcast as of the current date and time measured by the clock unit 1171 is scheduled to be multi-channel broadcast (step S1201). The judgment regarding multi-channel broadcasting is made based on whether sub-channel setting has been made. If it is judged that the subsequent program is an HDTV program (step S1201, NO), the monitoring unit 1170 continues the monitoring.

On the other hand, if it is judged that the subsequent program is scheduled to be broadcast on one of multi-channels, the monitoring unit 1170 checks the broadcast start time of the multi-channel broadcasting to see whether the current time is five minutes before the broadcast start time of the subsequent program (step S1203). The monitoring unit 1170 waits until five minutes before the program start (step S1203: NO). When the current time reaches five minutes before the program start (step S1203: YES), the monitoring unit 1170 outputs to the appli executing unit 1106 an instruction to start the application for presenting preview images in list form.

On receiving the application start instruction, the appli executing unit 1106 starts the application 1121, and operates in accordance with the application 1121 as described in the embodiment 1. Since the application 1121 performs basically the same processing as the application 121, no description is given here.

### Embodiment 3

An embodiment 3 of the present invention relates to the case where an HDTV broadcast of, for example, a baseball game is extended beyond the originally scheduled time. Here, one HDTV program or two SDTV programs are originally scheduled to be broadcast subsequently to the baseball game.

<Overview>

The processing performed in the embodiment 3 relates to the case where a live broadcast program is extended. In such a case, the broadcast station usually makes an arrangement to start multi-channel broadcasting, so that the extended program is broadcast simultaneously with the program originally scheduled to be broadcast subsequently. Generally, up to three SDTV programs can be broadcast on a single HDTV channel. Thus, in the case where the subsequent program is a single HDTV program or two SDTV programs, it is possible to create on additional channel for the continued broadcasting of the extended program. Note it is the broadcast station that decides whether to extend the live broadcasting.

A digital broadcast receiving apparatus of the embodiment 3 is basically identical in structure to the digital broadcast receiving apparatus of the embodiments 1 and 2. Thus, no description is given to the structure. The description below is given based on the structure of the digital broadcast receiving apparatus 100 of the embodiment 1.

<Data>

A description is now given to how program guide information is altered when unplanned multi-channel broadcasting takes place.

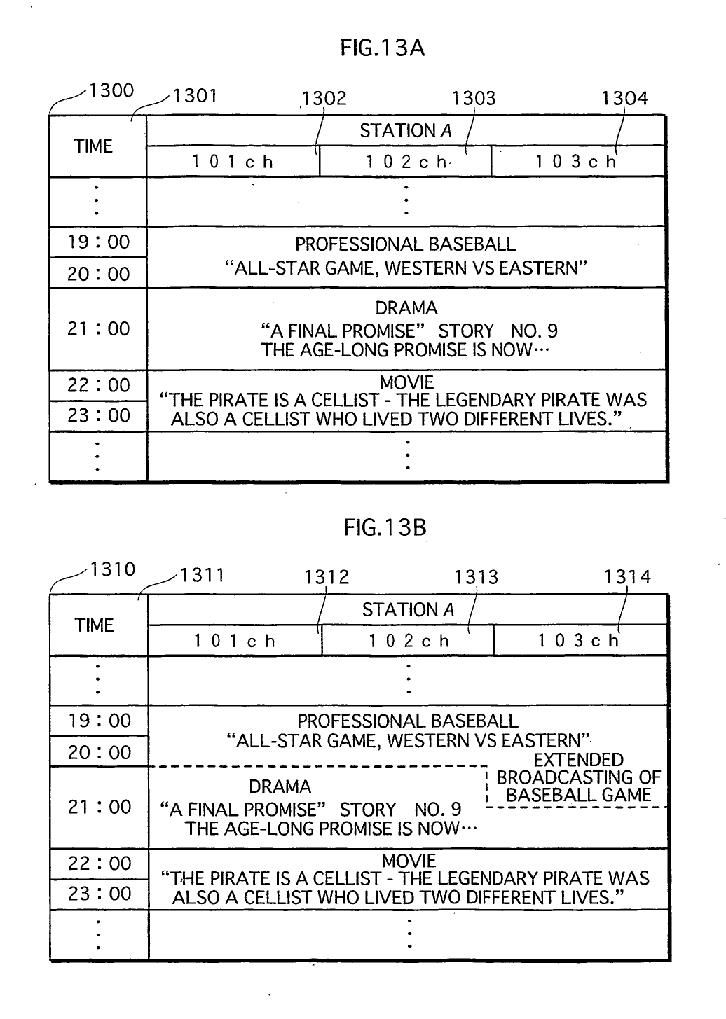

FIGS. 13A and 13B show examples of program guide tables relating to the embodiment 3. As shown in FIG. 13A, the program guide table 1300 provides contents of programs scheduled to be broadcast in respective time slots denoted as a time 1301 and on respective sub-channels 101ch, 102ch, and 103ch which are denoted by reference numerals 1302, 1303, and 1304, respectively. As shown in FIG. 13B, the program guide table 1310 provides contents of programs scheduled to be broadcast in respective time slots denoted as a time 1311 and on respective sub-channels 10ch, 102ch, and 103ch which are denoted by reference numerals 1312, 1313, and 1314, respectively.

The program guide table 1310 shows the original broadcast schedule. As shown in the figure, from 19:00, a professional baseball “All-Star Game, Western vs. Eastern” is scheduled to be broadcast. From 21:00, a drama called “A Final Promise” is scheduled to be broadcast. From 22:00, a movie called “The Pirate is a Cellist” is scheduled to be broadcast.

The program guide table 1300 shows the broadcast schedule altered due to extended broadcasting of the baseball game beyond the originally scheduled time shown in FIG. 13A. As shown in FIG. 13B, after the schedule change, the drama originally scheduled to be broadcast in high vision from 21:00 is now scheduled to be broadcast simultaneously with the extended baseball program on multi-channels. The drama is broadcast in high vision using two of the sub-channels instead of three. The extended baseball program is broadcast in standard definition on the sub-channel 103ch, which is denoted by 1314. When such a schedule change takes place, it is assumed that the broadcast station transmits an updated version of program guide information, so that the digital broadcast receiving apparatus 100 overwrites the currently stored program guide information with the newly transmitted version.

<Operations>

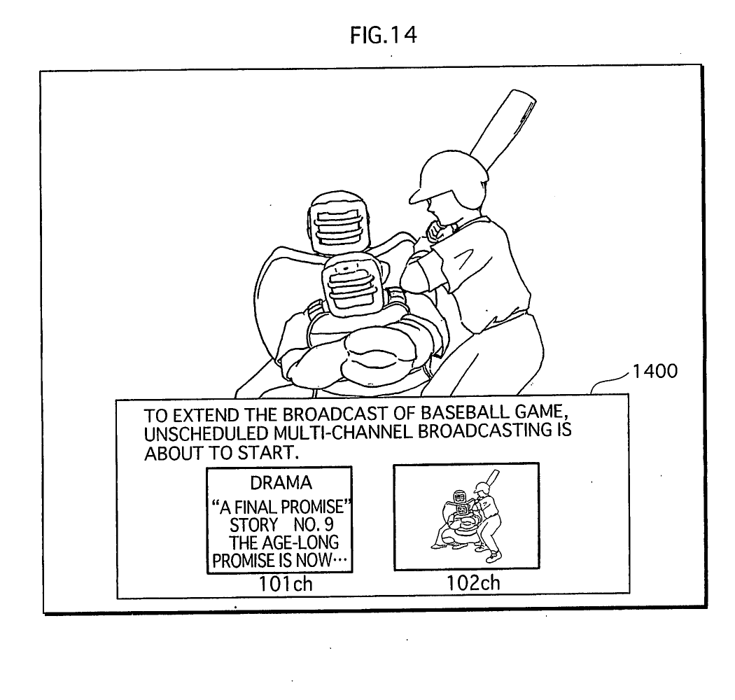

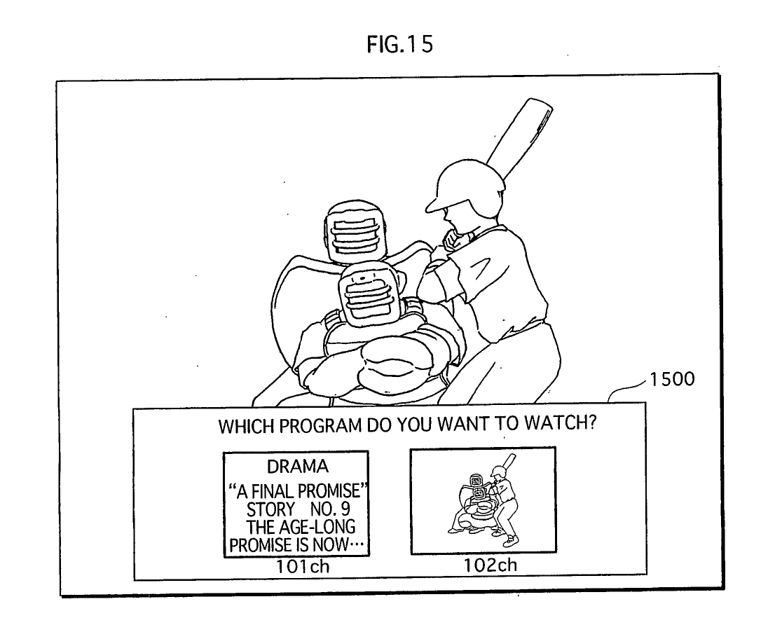

Next, a description is given to operating steps performed by the digital broadcast receiving apparatus according to the embodiment 3. The basic operating steps are identical to the ones described in the embodiment 1. Thus, the description here is given using a specific example in which the original broadcast schedule is altered as shown in FIG. 13B due to the extended broadcast of the baseball game. In the description, references are made to FIGS. 14-16 showing display screens presenting preview images prior to the unplanned multi-channel broadcasting.

Prior to the start of unplanned multi-channel broadcasting, the broadcast station transmits, similarly to the embodiment 1, an application that includes preview images overlaid on the TS. The application program is generated and transmitted by the broadcast station at the time of determining to extend the broadcast of the baseball game. The sub-channel on which the extended program is to be broadcast is determined in advance by the broadcast station, and the digital broadcast receiving apparatus is informed of the predetermined sub-channel. Normally, an extended program is broadcast on the third sub-channel. Being informed of the sub-channel for extended programs, the view control unit 103 is allowed to switch sub-channels at the start of multi-channel broadcasting.

The digital broadcast receiving apparatus starts the application immediately upon receipt. In accordance with the application, the digital broadcast receiving apparatus displays a GUI informing the user that the multi-channel broadcasting is about to start.

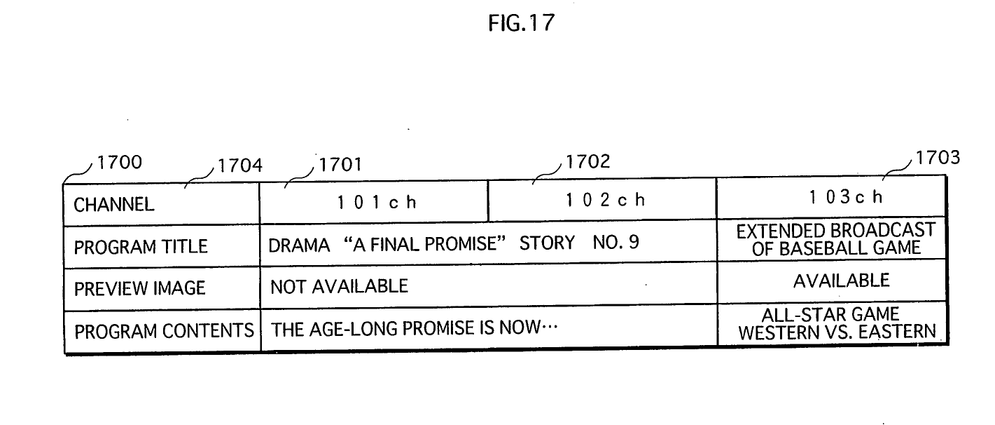

Specifically, the appli display unit 107 displays a GUI 1400 shown in FIG. 14, so that the user is informed that the unplanned multi-channel broadcasting is about to start. With viewing the GUI 1400, the user decides whether to check the contents of the programs scheduled to be broadcast on multi-channels, and makes an input as such on the remote controller 140. Different from the embodiment 1, the preview images are already presented as part of the first GUI 1400. Further, preview images to be presented are normally provided by the broadcast station. In the case where no preview image of a scheduled program is provided by the broadcast station, the digital broadcast receiving apparatus reads text data relating to the program from the EPG, and displays the text in place of a preview image. In this example, the broadcast station fails to provide a preview image of the subsequent program of drama. Thus, the information about the drama is displayed in text in a region of the GUI 1400 relating to the sub-channel 101ch. As FIG. 17 shows an example of the data structure, the EPG contains information regarding the program title, whether a preview image is available, and the contents of each program to be broadcast on the sub-channels 101ch, 102ch, and 103ch (i.e. sub-channels 1701, 1702, and 1703). Thus, the text data of the drama is based on the program title and the contents contained in the EPG.

Next, the appli executing unit 106 instructs, in accordance with the application, the appli display unit 107 to display a GUI 1500. The GUI 11500 prompts the user to select one program for viewing, form among the programs scheduled to be broadcast on the multi-channels.

After checking the contents of the two programs with the GUI 1500, the user selects one of the programs for viewing, by moving the cursor with the remote controller 140 to the preview image or the text data of the desired one of the programs.

When the operation receiving unit 109 receives the user input made to the remote controller 140, the digital broadcast receiving apparatus 100 stores the sub-channel of the user selected program to the storage unit 120.

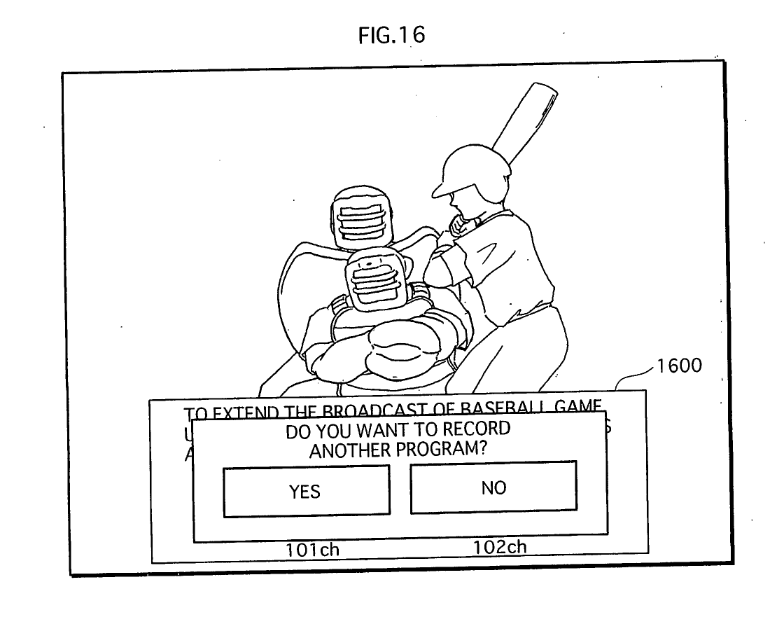

At the same time, the appli executing unit 106 displays a GUI 1600 shown in FIG. 16. The GUI 1600 prompts the user to input whether it is requested to record a program other than the program selected for viewing. Here, no prompt is made regarding whether to record the program having been viewed by that time. This is because it is assumed that the user has already made such setting for recording if the user had an intention of doing so.

At the start time of the multi-channel broadcasting, under the control of the view control unit 103, the tuner 101 receives the user-selected program and the program corresponding to the user-selected preview image is displayed on the display 160. In the case where it has been set to record another program broadcast in the same time slot, the record/playback control unit 104 records the preset program.

### Embodiment 4

An embodiment 4 of the present invention relates to the case where an HDTV program, such a live broadcast of a baseball game, is extended beyond the scheduled broadcast time. In that case, if the baseball game has been recorded, the recording is automatically continued until the end of the baseball program. In addition, if a program scheduled to be broadcast subsequently to the baseball program is preset to be recorded, a digital broadcast receiving apparatus of the embodiment 4 operates as described below. In the embodiment 4, the description is given based on the unplanned multi-channel broadcasting described in the embodiment 3 with reference to FIG. 13B.

The digital broadcast receiving apparatus according to the embodiment 4 is basically identical in structure to the digital broadcast receiving apparatus 100 of the embodiment 1. Thus, the description below is given only to operation of the digital broadcast receiving apparatus.

<Operation>

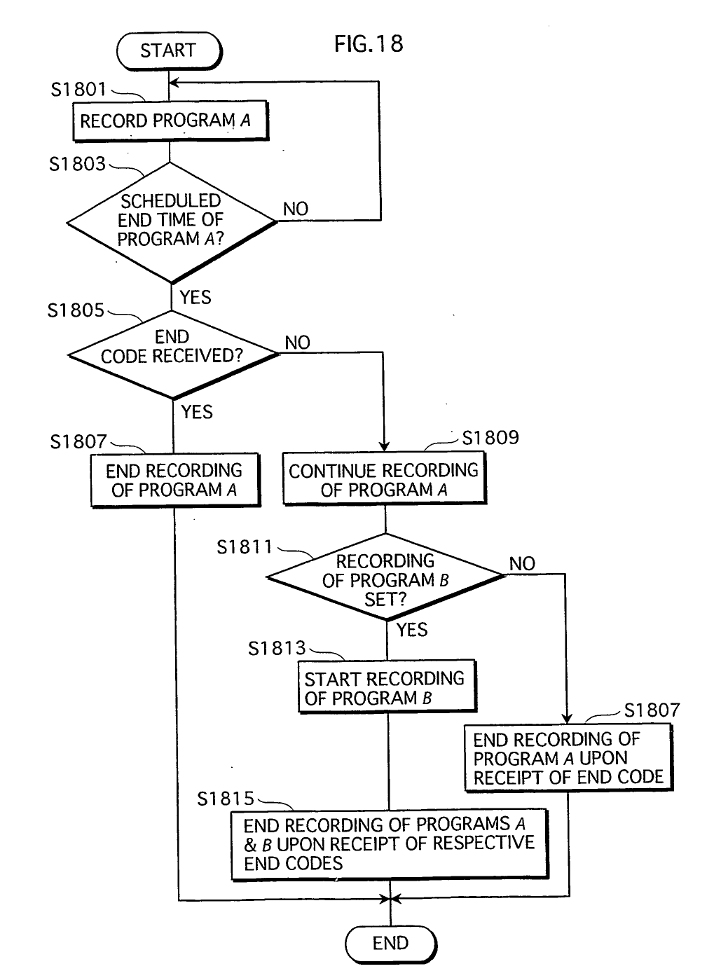

FIG. 18 is a flowchart of operating steps performed by the digital broadcast receiving apparatus 100 in the case where a currently broadcast program is extended beyond the originally scheduled time.

First of all, the digital broadcast receiving apparatus is currently recording a program A (step S1801) in accordance with user-made presetting. Thus, the recording is set to be terminated at the scheduled end time of the program A. At the scheduled end time of the program A (step S1803: YES), the record/playback control unit 104 checks whether an end code indicating the end point of the program A is transmitted in the TS carrying the program A (step S1805).

If the end code is transmitted (step S1805: YES), the record/playback control unit 104 stops recording the program A (step S1807). Then, the digital broadcast receiving apparatus 100 performs subsequent processing steps for displaying and recording the subsequent program.

If no end code is transmitted (step S1805: NO), it is judged that the broadcast of the program A is extended. Thus, the record/playback control unit 104 continues the recording of the program A (step S1809). In addition, the record/playback control unit 104 checks whether a program B originally scheduled to be broadcast at this point of time has been set to be recorded (step S1811). If the program B has been set to be recorded (step S1811: YES), the record/playback control unit 104 additionally records the program B (step S1813). The recording of programs A and B is continued until respective end codes are received. The record/playback control unit 104 stops recording the program A upon receipt of the end code for the program A, and stops recording the program B upon receipt of end codes for the programs B (step S1815).

If the program B has not been set to be recorded (step S1811: NO), the record/playback control unit 104 simply continues the recording of program A until the end code for the program A is received (step S1817).

<Supplemental Note>

Up this point, the present invention has been described by way of the embodiments 1-4. However, it is naturally appreciated that the present invention is in no way limited to the specific embodiments described above and various modifications including the following may be made.

(1) In the above embodiments, preview images are displayed at the time when HDTV broadcasting is switched to multi-channel broadcasting. It is also applicable to display preview images at the time when multi-channel broadcasting of new programs start subsequently to multi-channel broadcasting of another set of programs. Even when receiving a plurality of programs that are multi-channel broadcast, it is assumed that users usually view a single program on a display. With this being the situation, the present invention is effectively applicable upon transition from one program to a subsequent program both broadcast on one of multi-channels.

(2) As described above, the embodiment 4 relates to the case where the program A that the user is watching and recording is extended and the broadcast station starts unplanned multi-channel broadcasting of the extended program A and a program B. The program B is originally scheduled to be broadcast subsequently to the program A and has been set by the user to be recorded. In that case, the digital broadcast receiving apparatus is described to record both the programs A and B till the end. Alternatively, it is applicable to play back the program B simultaneously with recording (so-called “chase playback”) as of the point of time when an end code of the program A is received. In this case, the record/playback control unit sequentially stores the program B to the storage unit and simultaneously plays the program B on the display from the beginning by reading the recorded TS.

(3) In the above embodiment 3, it is described that the broadcast station generates and transmits preview images upon deciding to extend the broadcast of a program. Alternatively, it is applicable that the broadcast station prepares in advance a preview image of a sport program which is likely to be extended as well as a preview image of the following program.

(4) In the above embodiments, the digital broadcast receiving apparatus informs users about multi-channel broadcasting, a predetermined period of five minutes before the start of multi-channel broadcasting. Yet, the length of the predetermined period is not limited to five minutes, and may be ten minutes or any other length of time. In addition, the time period is determined by the broadcast station in the embodiment 1. Yet, the time period may be arbitrarily determined by a user in the case of the embodiment 2.

(5) In the embodiment 1, the appli information 310 includes a third preview image identifier. Yet, in the case where the number of programs broadcast on multi-channels is two, neither a third preview image nor its identifier is required to be transmitted.

(6) Each functional blocks of the digital broadcast receiving apparatus relating to display of preview images of programs may be embodied as part or entirety of a single Large Sale Integration (LSI) or Very Large Scale Integration (VLSI). It is also applicable to embody the functional blocks as a plurality of LSIs or VLSIs or any combination of one or more LSIs or VLSI with another circuit.

### INDUSTRIAL APPLICABILITY

The present invention is applicable to a digital television.

1. A digital broadcast receiving apparatus for receiving multi-channel broadcasting of programs, the multi-channel broadcasting being parallel transmission of a plurality of programs within a frequency bandwidth allocated for a single HDTV channel, comprising:
a receiving unit operable to receive a broadcast wave on an HDTV channel;
an information acquiring unit operable to acquire, a predetermined time period before a start of multi-channel broadcasting on the HDTV channel, pieces of program information in one-to-one relation with programs to be broadcast;
a display unit operable to display the acquired pieces of program information;
a viewing program selecting unit operable to select one of the displayed pieces of program information; and
a reproducing unit operable to reproduce a program corresponding to the selected piece of program information, from a broadcast start time of the program.

2. The digital broadcast receiving apparatus according to claim 1, further comprising:
a recording program selecting unit operable to select one of the displayed pieces of program information; and
a recording unit operable to record a program corresponding to the piece of program information selected by said recording program selecting unit, from a broadcast start time of the program.

3. The digital broadcast receiving apparatus according to claim 1, further comprising:
a recording unit operable to record one of the programs corresponding to program information not selected by said viewing program selecting unit.

4. The digital broadcast receiving apparatus according to claim 1,
wherein said information acquiring unit acquires the program information overlaid on a broadcast transport stream received by said receiving unit.

5. The digital broadcast receiving apparatus according to claim 1, further comprising:
a storage unit operable to store in advance an electric program guide,
wherein said information acquiring unit acquires the program information from the electric program guide.

6. The digital broadcast receiving apparatus according to claim 2, further comprising:
a detecting unit operable to detect an end of the program being recorded by said recording unit,
wherein said recording unit continues the recording until said detecting unit detects the end of the program.

7. The digital broadcast receiving apparatus according to claim 3, further comprising:
a detecting unit operable to detect an end of the program being recorded by said recording unit,
wherein said recording unit continues the recording until said detecting unit detects the end of the program.

8. The digital broadcast receiving apparatus according to claim 6, further comprising:
a channel switchover unit operable to switch sub-channels within the HDTV channel upon detecting, before said detecting unit detects the end of the program, that the broadcast of the currently recorded program is scheduled to be switched from one sub-channel to another sub-channel.

9. The digital broadcast receiving apparatus according to claim 7, further comprising:
a channel switchover unit operable to switch sub-channels within the HDTV channel upon detecting, before said detecting unit detects the end of the program, that the broadcast of the currently recorded program is scheduled to be switched from one sub-channel to another sub-channel.

10. The digital broadcast receiving apparatus according to claim 1,
wherein each piece of program information is a preview image of a corresponding program.

11. The digital broadcast receiving apparatus according to claim 1,
wherein each piece of program information is text data indicating contents of a corresponding program.

12. The digital broadcast receiving apparatus according to claim 1,
wherein each piece of program information is a still image of a scene of a corresponding program.

13. The digital broadcast receiving apparatus according to claim 6, wherein
when a program originally scheduled to be broadcast subsequently to the currently reproduced program is set in advance to be recorded, and the currently reproduced program is broadcast beyond an originally scheduled time in parallel with the subsequent program,
said recording unit starts to record the subsequent program, instead of the program corresponding to the piece of program information selected by said recording program selecting unit,
said detecting unit starts to detect an end of the program being reproduced, instead of an end of the program being recorded by said recording unit, and
said reproduction unit starts to reproduce the subsequent program recorded by said recording unit from a beginning, upon detection of the program end by said detecting unit.

14. The digital broadcast receiving apparatus according to claim 1, further comprising:
a record presetting unit operable to be set in advance to record a program according to a user input;
a recording unit operable to record the program set by said record presetting unit;
a detecting unit operable to detect an end of the program being recorded by said recording unit; and
a channel switchover unit operable to switch sub-channels within the HDTV channel, in synchronization with a switchover of a sub-channel on which the currently recorded program is broadcast to another sub-channel,
wherein when the program being recorded by said recording unit is broadcast beyond an originally scheduled time in parallel with a program originally scheduled to be subsequently broadcast,
said information acquiring unit acquires program information of both the programs,
said channel switchover unit switches the sub-channels, so that said recording unit continuously records the same program before and after the sub-channel switchover, and
said recording unit continues the recording until said detecting unit detects the end of the program.

15. A processing method of multi-channel broadcast programs, for use by a digital broadcast receiving apparatus that receives multi-channel broadcasting of programs, the multi-channel broadcasting being parallel transmission of a plurality of programs within a frequency bandwidth allocated for a single HDTV channel, comprising:
receiving a broadcast wave on an HDTV channel;
acquiring, a predetermined time period before a start of multi-channel broadcasting on the HDTV channel, pieces of program information in one-to-one relation with programs to be broadcast;
displaying the acquired pieces of program information;
selecting one of the displayed pieces of program information; and
reproducing a program corresponding to the selected piece of program information, from a broadcast start time of the program.

16. A computer-readable processing program of multi-channel broadcast programs, for execution on a digital broadcast receiving apparatus that receives multi-channel broadcasting of programs, the multi-channel broadcasting being parallel transmission of a plurality of programs within a frequency bandwidth allocated for a single HDTV channel, said computer-readable program comprising code operable to cause the digital broadcast receiving apparatus to:
receive a broadcast wave on an HDTV channel;
acquire, a predetermined time period before a start of multi-channel broadcasting on the HDTV channel, pieces of program information in one-to-one relation with programs to be broadcast;
display the acquired pieces of program information;
select one of the displayed pieces of program information; and
reproduce a program corresponding to the selected piece of program information, from a broadcast start time of the program.

17. An integrated circuit for use on a digital broadcast receiving apparatus that receives multi-channel broadcasting of programs, the multi-channel broadcasting being parallel transmission of a plurality of programs within a frequency bandwidth allocated for a single HDTV channel, comprising:
a receiving module operable to receive a broadcast wave on an HDTV;
an information acquiring module operable to acquire, a predetermined time period before a start of multi-channel broadcasting on the HDTV channel, pieces of program information in one-to-one relation with programs to be broadcast;
a display module operable to display the acquired pieces of program information;
a viewing program selecting module operable to select one of the displayed pieces of program information; and
a reproducing module operable to reproduce a program corresponding to the selected piece of program information, from a broadcast start time of the program.
